(19) United States
(12) Patent Application Publication
(10) Pub. No.: US 2015/0214629 A1
(43) Pub. Date: Jul. 30, 2015

(54) ANTENNA

(71) Applicant: NIHON DENGYO KOSAKU CO., LTD., Tokyo (JP)

(72) Inventors: Hiroki Hagiwara, Tokyo (JP); Hidenobu Hiramatsu, Tokyo (JP); Tomoyuki Soga, Tokyo (JP); Takeshi Shimura, Tokyo (JP)

(73) Assignee: NIHON DENGYO KOSAKU CO., LTD., Tokyo (JP)

(21) Appl. No.: 14/424,244

(22) PCT Filed: Aug. 21, 2013
(86) PCT No.: PCT/JP2013/072288

§ 371 Date: Feb. 26, 2015

(30) Foreign Application Priority Data
Aug. 27, 2012 (JP) 2012-186491

(51) Int. Cl. H01Q 9/28; H01Q 21/29; H01Q 19/10; H01Q 21/24

(52) U.S. Cl. CPC H01Q 9/285; H01Q 21/24; H01Q 21/293; H01Q 19/108

(57) ABSTRACT

An omnidirectional vertical polarization antenna is configured of monopole antennas, the number of which is k (k≧3), disposed on a circumference of a circle at equal spaces. An omnidirectional horizontal polarization antenna is configured of first to m-th omnidirectional antennas stacked in m (m≧2) layers in a first direction perpendicular to a reflector, and each of the first to m-th omnidirectional antennas is configured of half-wave dipole antennas, the number of which is n. The half-wave dipole antennas, the number of which is n (n≧3), configuring each of the first to m-th omnidirectional antennas are respectively configured of arc-shaped conductive bodies, and disposed, at equal spaces, on each of circumferences of circles, the number of which is m, having different diameters, when viewed from a direction opposite to the first direction. The first to m-th omnidirectional antennas are stacked from the reflector in the first direction. Accordingly, there is provided a dual polarization antenna using omnidirectional antennas, achieving omnidirectivity as the directivity in the horizontal plane with less deviation of directivity than before, by using the half-wave dipole antennas.

### TECHNICAL FIELD

The present invention relates to an antenna such as an omnidirectional antenna and a dual polarization antenna, and specifically to a technique that is effective for achieving omnidirectivity as directivity in a horizontal plane, by using a half-wave dipole antenna.

### BACKGROUND ART

Radio waves of vertical polarization are used for mobile communication using mobile phones or the like. Therefore, a half-wave dipole antenna for the vertical polarization is often used as an array antenna of a mobile communication base station antenna. The half-wave dipole antenna has omnidirectivity in a plane perpendicular to an axis of the dipole (in a plane of the magnetic field (H)), which has been publicly known.

Nowadays, there is a demand for, as the mobile communication base station antenna, a dual polarization antenna that can receive radio waves of both horizontal polarization and vertical polarization, and that is omnidirectional in both polarizations.

However, if the half-wave dipole antenna is used as an antenna receiving radio waves of horizontal polarization, it has radiation pattern of figure-of-eight shape in a plane including the dipole axis (in a plane of the electric field (E)). For this reason, if the half-wave dipole antenna is used as an antenna receiving the radio waves of the horizontal polarization, it is difficult to obtain omnidirectivity as radiation pattern in the horizontal plane.

To address the aforementioned problem, a patent document 1 described below discloses a half-wave dipole antenna curved into an arc to obtain omnidirectivity as radiation pattern in the horizontal plane.

### CITATION LIST

### Patent Literature

Patent Document 1: Japanese Patent Application Laid-Open Publication No. Hei 11-68446

### SUMMARY OF INVENTION

### Technical Problem

However, the antenna disclosed in the patent document 1 only obtains radiation pattern that are approximately omnidirectional and have deviation of 5 dB or less, as described in the aforementioned patent document 1.

The present invention is to address the aforementioned problem of the conventional art, and an object of the present invention is to provide an omnidirectional antenna achieving omnidirectivity as directivity in the horizontal plane with less deviation than before, by using a half-wave dipole antenna.

Another object of the present invention is to provide a dual polarization antenna using the aforementioned omnidirectional antenna.

The aforementioned and the other objects and novel features of the present invention will be clarified by description of this specification and attached drawings.

### Solution to Problem

The following is a brief summary of the representative elements of the invention disclosed in this application:

(1) There is provided an antenna including: half-wave dipole antennas, the number of which is n being an integer of 3 or more, the half-wave dipole antennas being fed in the same phase. The half-wave dipole antennas, the number of which is n, are configured of arc-shaped conductive bodies each curved to form part of a circumference of a circle, and are disposed on the circumference of the circle at equal spaces.

(2) In (1), the antenna further includes monopole antennas the number of which is k being an integer of 3 or more, the monopole antennas being disposed on a circumference of a circle at equal spaces, being fed in the same phase, transmitting and receiving a polarized wave vertical to the circle, and having omnidirectivity at a direction parallel to a plane including the circle.

(3) There is provided an antenna including: a reflector; and a first omnidirectional antenna to a m-th omnidirectional antenna stacked in a first direction perpendicular to a plane of the reflector, and having omnidirectivity at a direction parallel to a surface of the reflector, wherein m is an integer of 2 or more, wherein each of the first omnidirectional antenna to the m-th omnidirectional antenna has half-wave dipole antennas the number of which is n being an integer of 3 or more, the half-wave dipole antennas being fed in the same phase, the half-wave dipole antennas, the number of which is n, are respectively configured of arc-shaped conductive bodies each curved to form part of a circumference of a circle, and are disposed on the circumference of the circle at equal spaces, when viewed from a direction opposite to the first direction, a diameter of the circle is different among the first omnidirectional antenna to the m-th omnidirectional antenna, and a polarization parallel to the surface of the reflector is transmitted and received.

(4) In (3), the antenna further includes monopole antennas the number of which is k being an integer of 3 or more, the monopole antennas being disposed on the reflector, being disposed on a circumference of a circle at equal spaces, being fed in the same phase, transmitting and receiving a polarization vertical to the surface of the reflector, and having omnidirectivity at a direction parallel to the surface of the reflector.

(5) In (3) or (4), at least any one of the first omnidirectional antenna to the m-th omnidirectional antenna has, near the half-wave dipole antennas the number of which is n, parasitic elements the number of which is n.

(6) In any one of (1) to (5), the n is 3 or 4.

(7) In (2) or (4), the k is 3 or 4.

(8) In any one of (3) to (7), the m is 2.

### Advantageous Effects of Invention

An effect obtained by the representative elements of the invention disclosed in this application will be briefly explained as follows.

According to the present invention, it is possible to provide an omnidirectional antenna and a dual polarization antenna achieving omnidirectivity as directivity in the horizontal plane, with less deviation of the directivity than before.

### BRIEF DESCRIPTION OF DRAWINGS

FIG. 1 is a perspective view for illustrating a schematic configuration of a dual polarization antenna of the example of this invention;

FIG. 2 is a side view of the dual polarization antenna of the example of this invention;

FIG. 3 is a diagram for illustrating the second omnidirectional horizontal polarization antenna of the example of this invention;

FIG. 4 is a diagram for illustrating the parasitic elements of the example of this invention;

FIG. 5 is a diagram for illustrating the first omnidirectional horizontal polarization antenna of the example of this invention;

FIG. 6 is a diagram for illustrating the omnidirectional vertical polarization antenna of the example of this invention;

FIG. 7 is a graph showing radiation pattern of the horizontal polarization (radiation pattern in a plane of the electric field) at the frequency f1 (800 MHz frequency band), of the dual polarization antenna of the example of this invention;

FIG. 8 is a graph showing radiation pattern of the horizontal polarization(radiation pattern in the plane of the electric field) at the frequency f2 (1.5 GHz frequency band), of the dual polarization antenna of the example of this invention;

FIG. 9 is a graph showing radiation pattern of the horizontal polarization (radiation pattern in the plane of the electric field) at the frequency f3 (2.0 GHz frequency band), of the dual polarization antenna of the example of this invention;

FIG. 10 is a graph showing radiation pattern of the vertical polarization (radiation pattern in a plane of a magnetic field) at the frequency f1 (800 MHz frequency band), of the dual polarization antenna of the example of this invention;

FIG. 11 is a graph showing radiation pattern of the vertical polarization (radiation pattern in the plane of the magnetic field) at the frequency f2 (1.5 GHz frequency band), of the dual polarization antenna of the example of this invention;

FIG. 12 is a graph showing radiation pattern of the vertical polarization (radiation pattern in the plane of the magnetic field) at the frequency f3 (2.0 GHz frequency band), of the dual polarization antenna of the example of this invention;

FIG. 13 is a graph showing frequency characteristics of a voltage standing wave ratio (VSWR) of the omnidirectional horizontal polarization antennas of the dual polarization antenna of the example of this invention;

FIG. 14 is a graph showing frequency characteristics of VSWR of the omnidirectional vertical polarization antenna of the dual polarization antenna of the example of this invention;

FIG. 15 is a perspective view for illustrating a schematic configuration of a modified example 1 of the horizontal polarization antenna of this invention;

FIG. 16 is a perspective view for illustrating a schematic configuration of a modified example 2 of the horizontal polarization antenna of the present invention; and

FIG. 17 is a perspective view for illustrating a schematic configuration of a modified example 3 of the horizontal polarization antenna of the present invention.

### DESCRIPTION OF EMBODIMENTS

Hereinafter, examples of the present invention will be described in detail with reference to attached drawings.

Note that the same reference numerals are used for elements having the same functions in all drawings for illustrating the examples, and description thereof is not repeated. The examples described below are not intended to limit the scope of claims of the invention.

### EXAMPLE 1

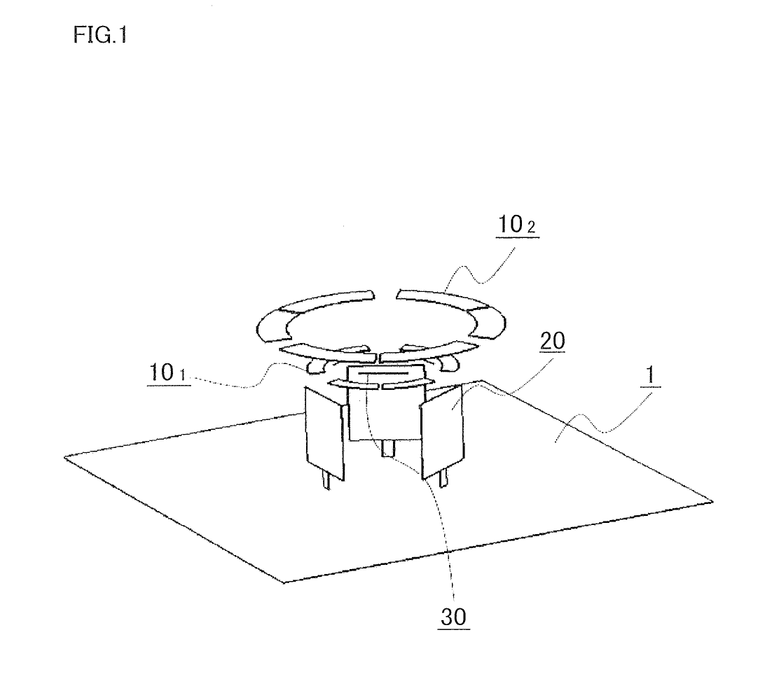

FIG. 1 is a perspective view for illustrating a schematic configuration of a dual polarization antenna of the example of this invention.

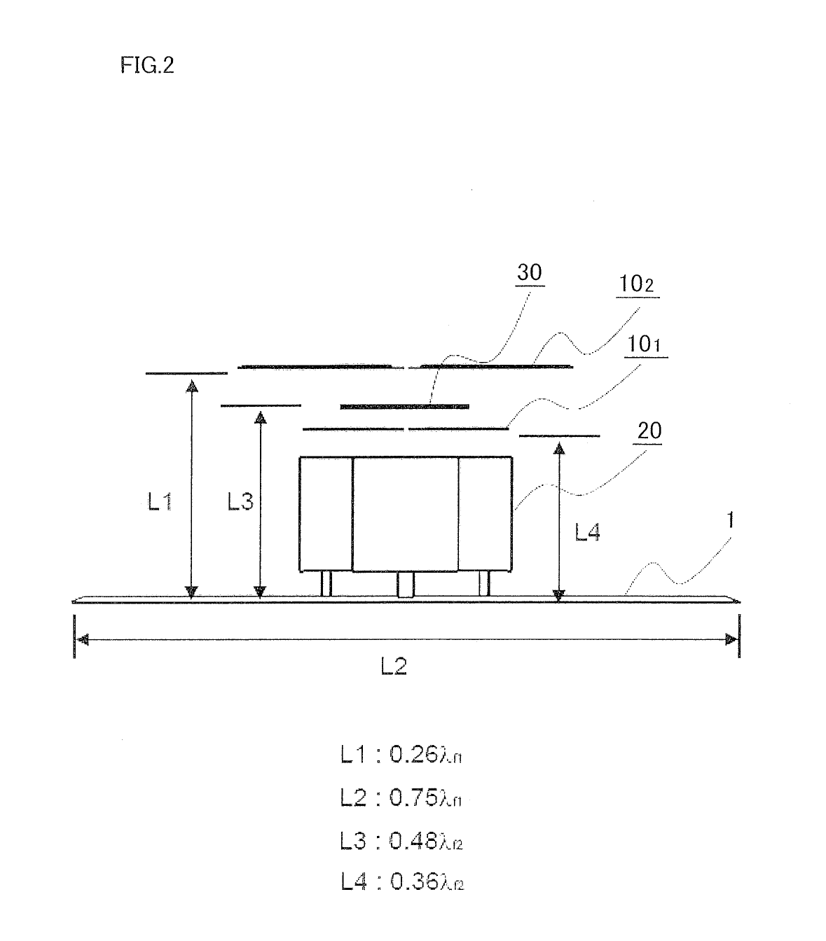

FIG. 2 is a side view of the dual polarization antenna of the example of this invention.

In FIGS. 1 and 2, 1 denotes a reflector, 20 denotes an omnidirectional vertical polarization antenna, 10₁ denotes a first omnidirectional horizontal polarization antenna, 30 denotes parasitic elements, and 10₂ denotes a second omnidirectional horizontal polarization antenna.

The dual polarization antenna of the example is disposed so that the surface of the reflector 1 is parallel to the ground. Thus, in FIG. 2, the up-and-down direction of the paper corresponds to the vertical direction, and the right-and-left direction of the paper corresponds to the horizontal direction. Further, a polarization of an electric field oscillating in the vertical direction is represented as a vertical polarization, and a polarization of an electric field oscillating in the horizontal direction is represented as a horizontal polarization.

The dual polarization antenna of the example emits radio waves of horizontal polarization and vertical polarization having three frequencies containing a frequency f1 (800 MHz frequency band), a frequency f2 (1.5 GHz frequency band) and a frequency f3 (2.0 GHz frequency band).

As shown in FIG. 2, the reflector 1 is configured of a quadrangular conductive plate having each side of L2 (=0.75λ_{f1}). The reflector 1 may be formed on a dielectric substrate by a printed-circuit technique, for example. Note that λ_{f1} is a free-space wavelength at the frequency f1.

The omnidirectional vertical polarization antenna 20, which emits radio waves of vertical polarization, is disposed on the reflector 1.

Further, the first omnidirectional horizontal polarization antenna 10₁ and the second omnidirectional horizontal polarization antenna 10₂ are disposed above the omnidirectional vertical polarization antenna 20.

Furthermore, the parasitic elements 30 are disposed above the first omnidirectional horizontal polarization antenna 10₁ (between the first omnidirectional horizontal polarization antenna 10₁ and the second omnidirectional horizontal polarization antenna 10₂).

As shown in FIG. 1, the omnidirectional vertical polarization antenna 20 is configured of three monopole antennas.

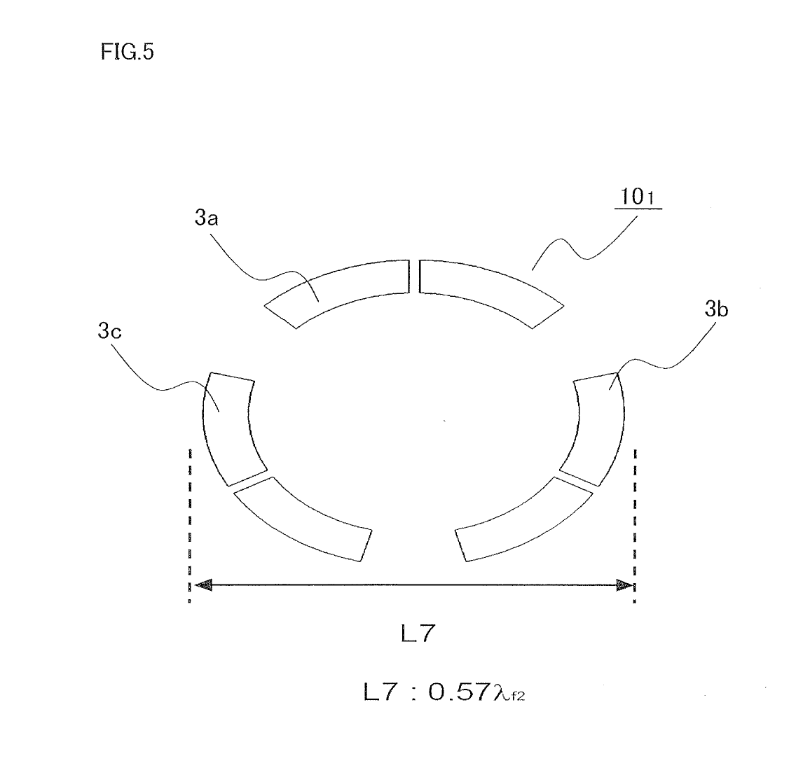

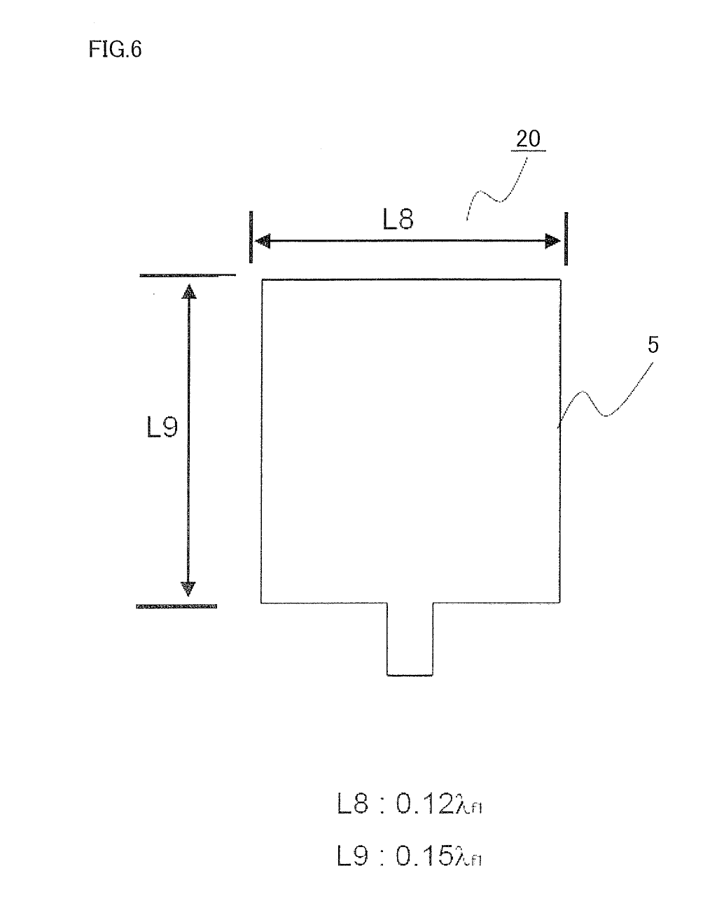

FIG. 6 is a diagram for illustrating the omnidirectional vertical polarization antenna 20 of the example of this invention.

The monopole antennas of the example are each configured of a rectangular conductive plate 5 having a shorter side of L8 (=0.12λ_{f1}) and a longer side of L9 (=0.15λ_{f1}).

The three monopole antennas respectively configured of the rectangular conductive plates 5 emit the radio waves of the omnidirectional vertical polarization at three frequencies f1, f2 and f3. Note that the rectangular conductive plate 5 may be formed on a dielectric substrate by a printed-circuit technique, or metal plate may be used therefor. The three monopole antennas configured of the rectangular conductive plates 5 are disposed so that centerlines passing through the centers thereof intersect with each other at a 120-degree angle.

FIG. 5 is a diagram for illustrating the first omnidirectional horizontal polarization antenna 10₁ of the example of this invention.

The first omnidirectional horizontal polarization antenna 10₁ of the example is configured of three half-wave dipole antennas (3a, 3b, 3c) that are configured of arc-shaped conductive bodies each curved to form part of a circumference of a certain circle, and that are disposed on the circumference of the certain circle at equal spaces.

The half-wave dipole antennas (3a, 3b, 3c) emit the radio waves of the omnidirectional horizontal polarization at the frequencies (f2, f3).

A diameter of a circumscribed circle of the three half-wave dipole antennas (3a, 3b, 3c) is set at L7 (=0.57λ_{f2}). An interval between the three half-wave dipole antennas (3a, 3b, 3c) and the reflector 1 is set at L4 (=0.36λ_{f2}) (refer to FIG. 2). Note that λ_{f2} is a free-space wavelength at the frequency f2.

The three half-wave dipole antennas (3a, 3b, 3c) may be formed on a dielectric substrate 2 by a printed-circuit technique, or metal plates, bars, tubes or the like may be used therefor.

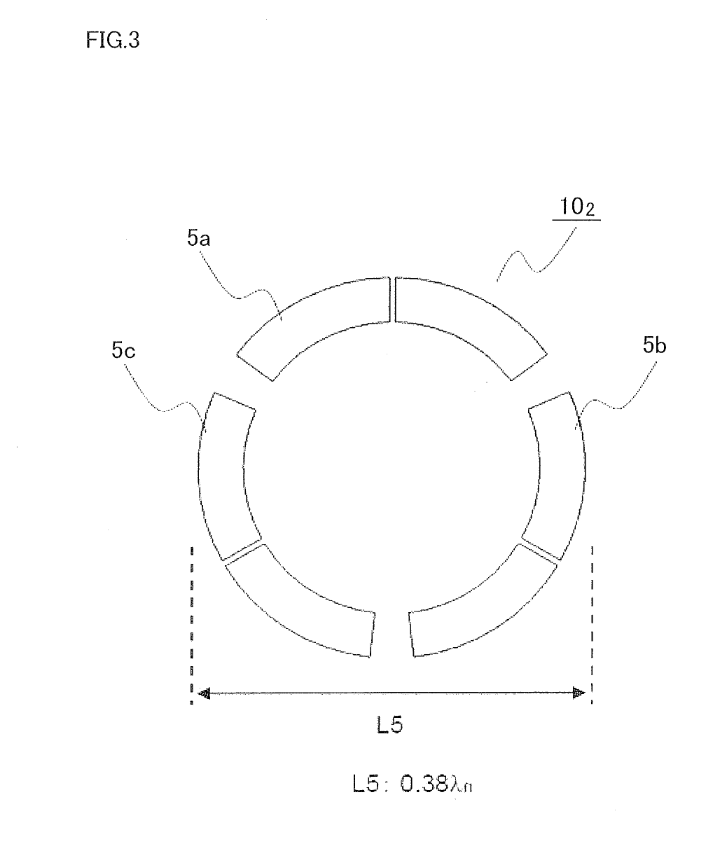

FIG. 3 is a diagram for illustrating the second omnidirectional horizontal polarization antenna 10₂ of the example of this invention.

The second omnidirectional horizontal polarization antenna 10₂ of the example is configured of three half-wave dipole antennas (5a, 5b, 5c) that are configured of arc-shaped conductive bodies each curved to form part of a circumference of a certain circle, and that are disposed on the circumference of the certain circle at equal spaces.

The half-wave dipole antennas (5a, 5b, 5c) emit the radio waves of the horizontal polarization at the frequency (f1). A diameter of a circumscribed circle of the three half-wave dipole antennas (5a, 5b, 5c) is set at L5 (=0.38λ_{f1}). An interval between the three half-wave dipole antennas (5a, 5b, 5c) and the reflector 1 is set at L1 (=0.26λ_{f1}) (refer to FIG. 2).

The three half-wave dipole antennas (5a, 5b, 5c) may be formed on a dielectric substrate 2 by a printed-circuit technique, or metal plates, bars, tubes or the like may be used therefor.

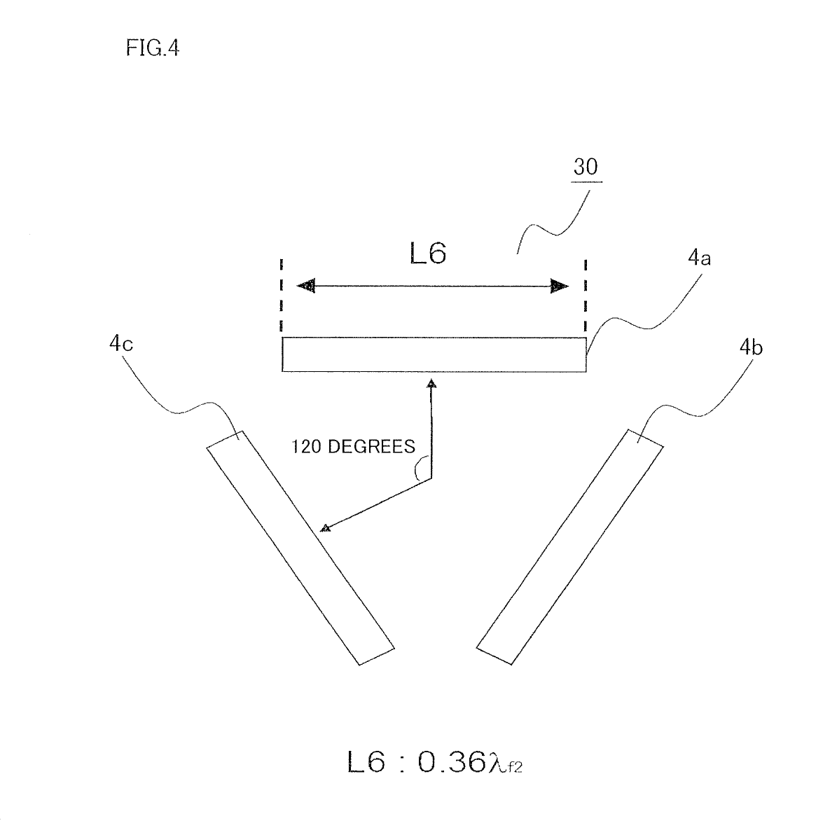

FIG. 4 is a diagram for illustrating the parasitic elements 30 of the example of this invention. As illustrated in FIG. 4, the parasitic elements 30 are configured of three conductive bodies (4a, 4b, 4c) having the length of L6 (=0.36λ_{f2}). An interval between the three conductive bodies (4a, 4b, 4c) and the reflector 1 is set at L3 (=0.48λ_{f2}) (refer to FIG. 2).

Note that the three conductive bodies (4a, 4b, 4c) may be formed on a dielectric substrate 2 by a printed-circuit technique, or metal plates, bars, tubes or the like may be used therefor.

As shown in FIG. 4, above the first omnidirectional horizontal polarization antenna 10₁, the three conductive bodies (4a, 4b, 4c) have centerlines passing through the centers thereof corresponding to the centers of the three half-wave dipole antennas (3a, 3b, 3c), and the three conductive bodies (4a, 4b, 4c) are disposed so that the centerlines passing through the centers intersect with each other at a 120-degree angle.

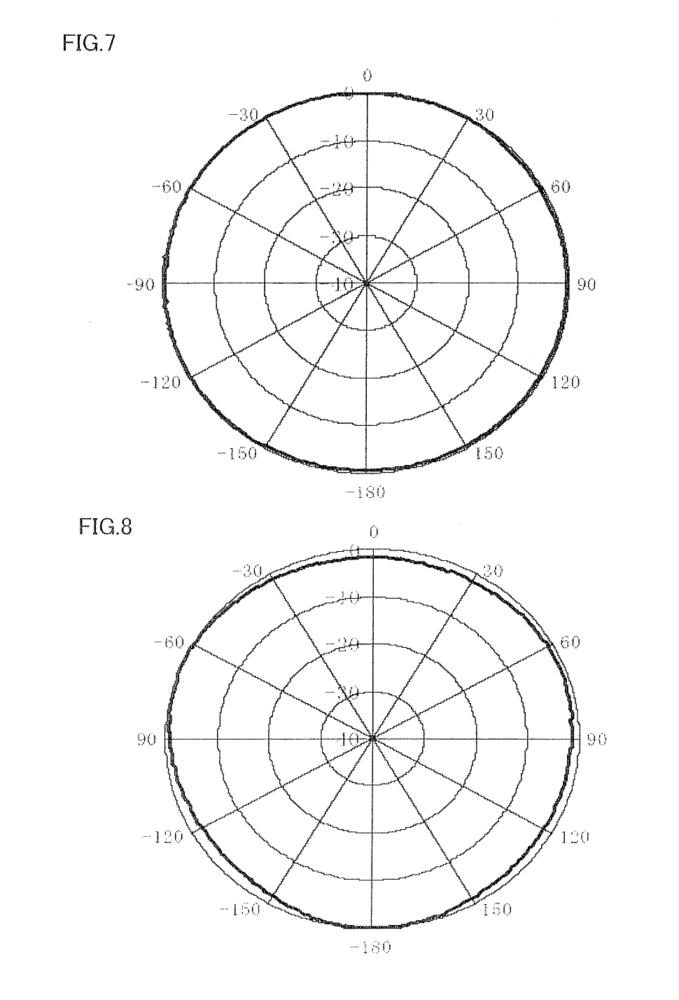

FIG. 7 is a graph showing radiation pattern of the horizontal polarization (radiation pattern in a plane of the electric field) at the frequency f1 (800 MHz frequency band), of the dual polarization antenna of the example of this invention.

FIG. 8 is a graph showing radiation pattern of the horizontal polarization (radiation pattern in the plane of the electric field) at the frequency f2 (1.5 GHz frequency band), of the dual polarization antenna of the example of this invention.

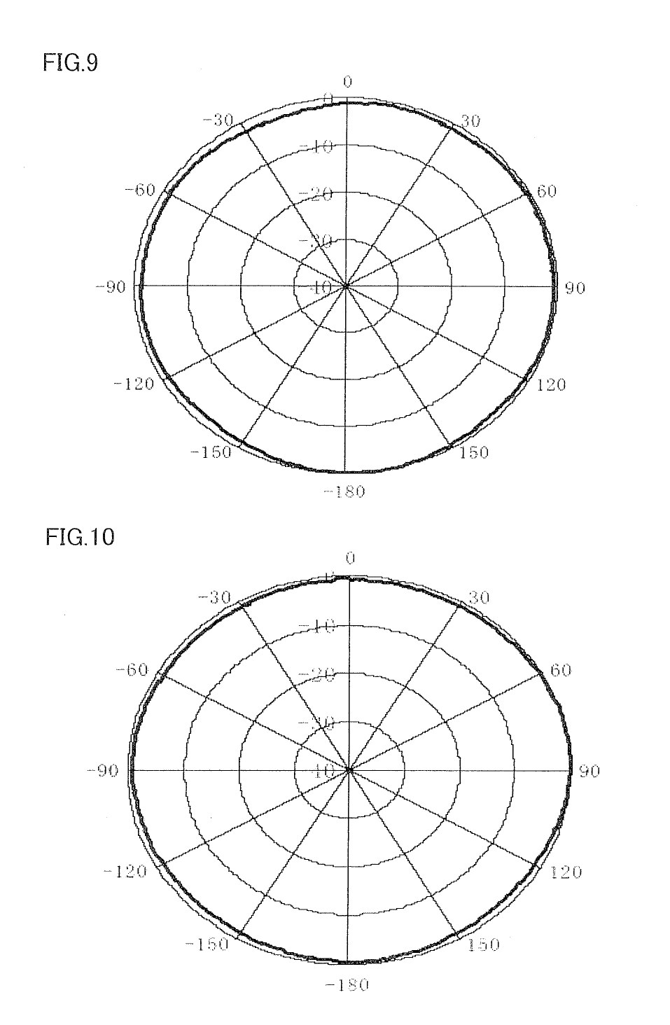

FIG. 9 is a graph showing radiation pattern of the horizontal polarization (radiation pattern in the plane of the electric field) at the frequency f3 (2.0 GHz frequency band), of the dual polarization antenna of the example of this invention.

As shown in FIGS. 7 to 9, in the example, omnidirectional pattern with less deviation of directivity are obtainable as the radiation pattern of the horizontal polarization.

As mentioned above, although the half-wave dipole antenna has the radiation pattern of figure-of-eight shape in the plane including the dipole axis (in the plane of the electric field (E)), omnidirectional pattern are obtainable in the plane including the dipole axis (in the horizontal plane; in the plane of the electric field (E)) by disposing three half-wave dipole antennas configured of arc-shaped conductive bodies on the circumference of the certain circle at equal spaces as shown in the example.

FIG. 10 is a graph showing radiation pattern of the vertical polarization (radiation pattern in a plane of a magnetic field) at the frequency f1 (800 MHz frequency band), of the dual polarization antenna of the example of this invention.

FIG. 11 is a graph showing radiation pattern of the vertical polarization (radiation pattern in the plane of the magnetic field) at the frequency f2 (1.5 GHz frequency band), of the dual polarization antenna of the example of this invention.

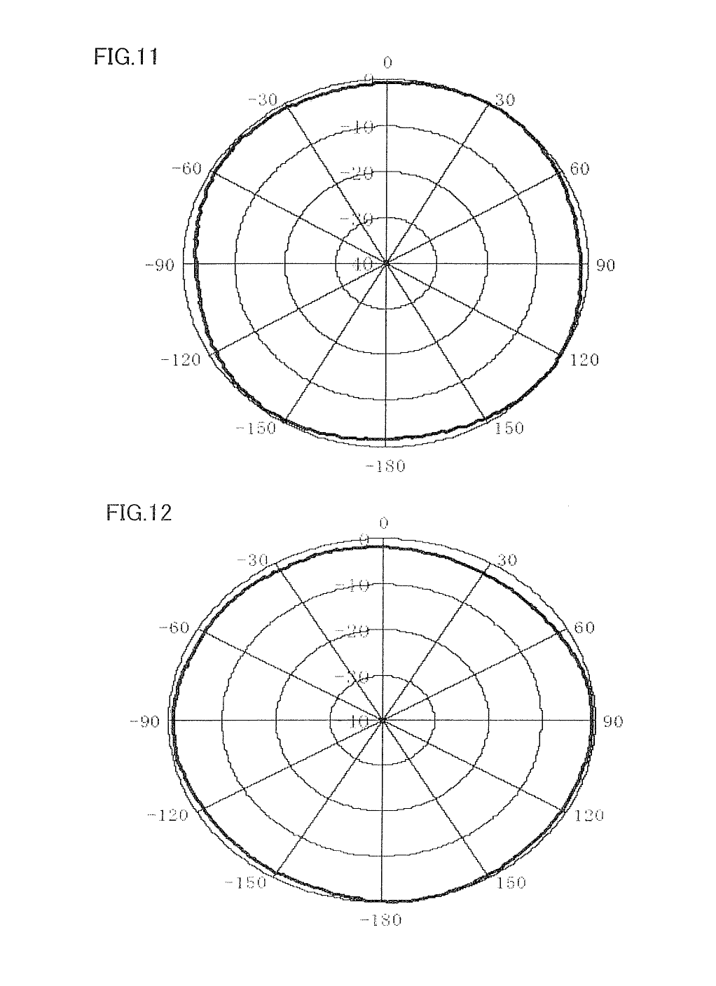

FIG. 12 is a graph showing radiation pattern of the vertical polarization (radiation pattern in the plane of the magnetic field) at the frequency f3 (2.0 GHz frequency band), of the dual polarization antenna of the example of this invention.

As shown in FIGS. 10 to 12, in the example, omnidirectional pattern with less deviation of directivity are also obtainable as the radiation pattern of the vertical polarization.

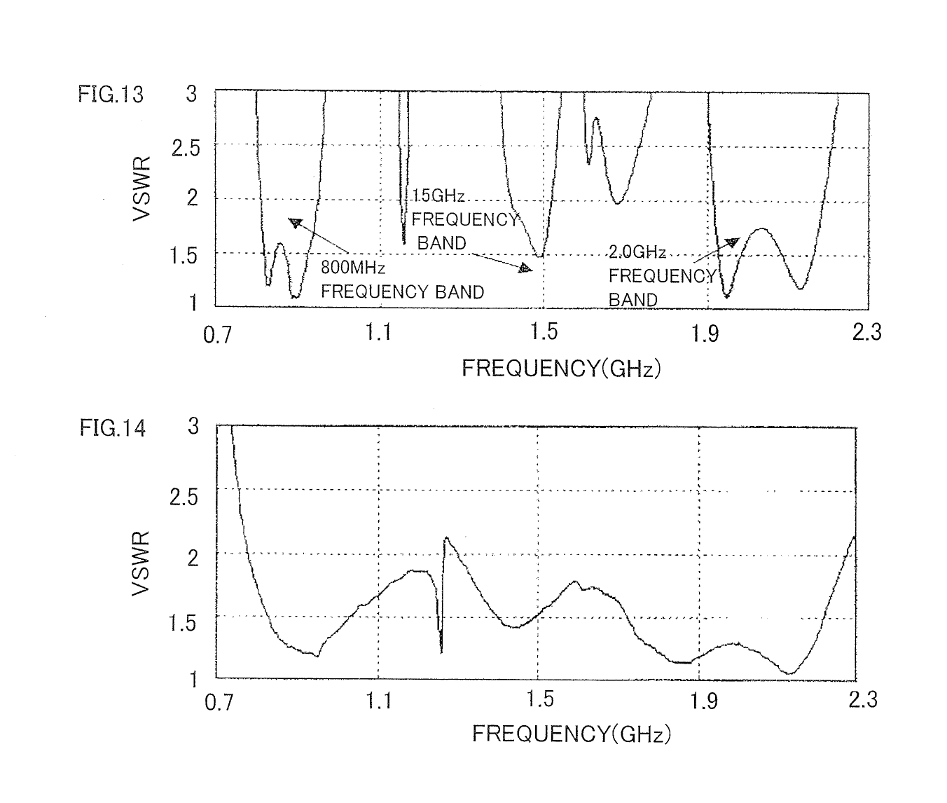

FIG. 13 is a graph showing frequency characteristics of a voltage standing wave ratio (VSWR) of the omnidirectional horizontal polarization antennas of the dual polarization antenna of the example of this invention, and FIG. 14 is a graph showing frequency characteristics of VSWR of the omnidirectional vertical polarization antenna of the dual polarization antenna of the example of this invention.

The 1.5 GHz frequency band and the 2.0 GHz frequency band of the horizontal polarization shown in FIG. 13 correspond to the VSWR of the three half-wave dipole antennas (3a, 3b, 3c) configuring the first omnidirectional horizontal polarization antenna 10₁. The 800 MHz frequency band of the horizontal polarization corresponds to the VSWR of the three half-wave dipole antennas (5a, 5b, 5c) configuring the second omnidirectional horizontal polarization antenna 10₂.

As shown in FIG. 14, the VSWR of the three monopole antennas configured of rectangular conductive plates 5, which configure the omnidirectional vertical polarization antenna 20, has wideband characteristics.

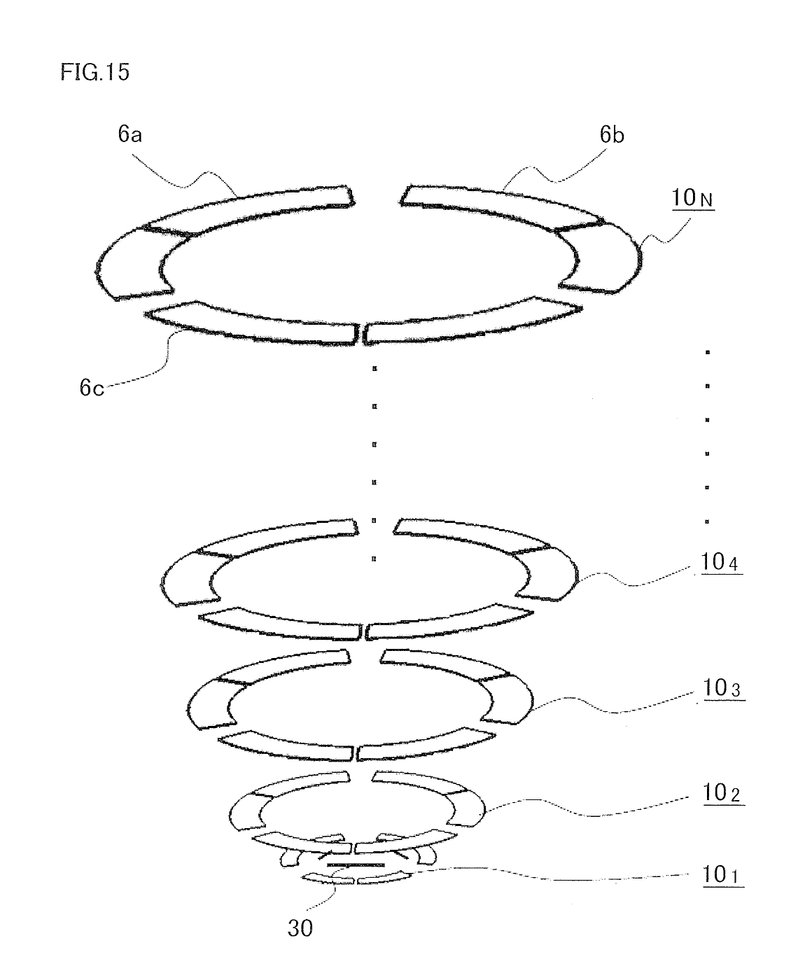

FIG. 15 is a perspective view for illustrating a schematic configuration of a modified example 1 of the horizontal polarization antenna of this invention.

The horizontal polarization antenna shown in FIG. 15 is omnidirectional horizontal polarization antenna s configured of the first omnidirectional horizontal polarization antenna 10₁, the second omnidirectional horizontal polarization antenna 10₂ to a N-th omnidirectional horizontal polarization antenna 10_{N}, wherein N is an integer of 4 or more.

Each of the first omnidirectional horizontal polarization antenna 10₁, the second omnidirectional horizontal polarization antenna 10₂ to the N-th omnidirectional horizontal polarization antenna 10_{N} is configured of three half-wave dipole antennas (6a, 6b, 6c) that are configured of arc-shaped conductive bodies each curved to form part of a circumference of a certain circle, and that are disposed on the circumference of the certain circle at equal spaces.

Note that, in the modified example 1 shown in FIG. 15, the parasitic elements 30 are disposed above at least one of the first omnidirectional horizontal polarization antenna 10₁ to the (N−1)-th omnidirectional horizontal polarization antenna 10_{N-1}. FIG. 15 illustrates the case in which the parasitic elements 30 are disposed above the first omnidirectional horizontal polarization antenna 10₁.

The dual polarization antenna shown in FIG. 15 can emit radio waves of omnidirectional horizontal polarization at frequencies the number of which is N or more.

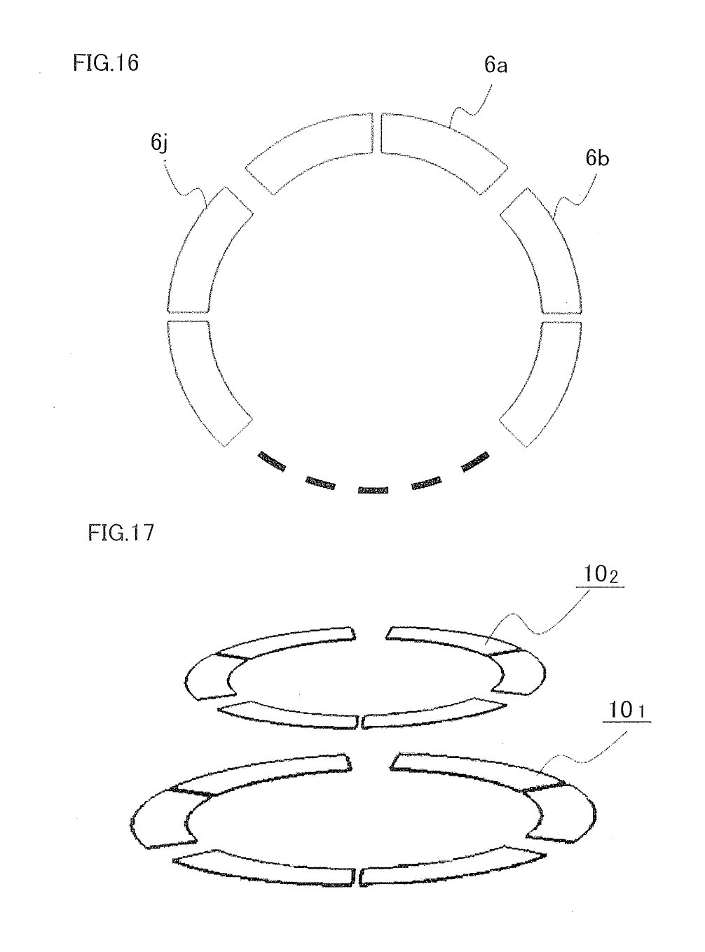

FIG. 16 is a perspective view for illustrating a schematic configuration of a modified example 2 of the horizontal polarization antenna of the present invention.

The horizontal polarization antenna shown in FIG. 16 is omnidirectional horizontal polarization antenna s configured of the first omnidirectional horizontal polarization antenna 10₁, the second omnidirectional horizontal polarization antenna 10₂ to the N-th omnidirectional horizontal polarization antenna 10_{N}, and each of them is configured of half-wave dipole antennas (6a, 6b, to 6j), the number of which is j as an integer of 4 or more, configured of arc-shaped conductive bodies and disposed on the circumference of the certain circle at equal spaces.

In the modified example 2 shown in FIG. 16, omnidirectional pattern with less deviation of directivity are obtainable as the horizontal polarization characteristics.

Note that the omnidirectional vertical polarization antenna may be configured of monopole antennas the number of which is k as an integer of 4 or more. In this case, omnidirectional pattern with less deviation of directivity are obtainable as the vertical polarization characteristics.

FIG. 17 is a perspective view for illustrating a schematic configuration of a modified example 3 of the horizontal polarization antenna of this invention.

In the horizontal polarization antenna shown in FIG. 17, the first omnidirectional horizontal polarization antenna 10₁, which is disposed near the reflector 1 and configures the omnidirectional horizontal polarization antenna, emits the frequency f1 (800 MHz frequency band), and the second omnidirectional horizontal polarization antenna 10₂, which emits the two frequencies f2 (1.5 GHz frequency band) and f3 (2.0 GHz frequency band), is disposed on the first omnidirectional horizontal polarization antenna 10₁.

Since each of the horizontal polarization antenna s shown in FIG. 17 is configured of the three half-wave dipole antennas that are configured of arc-shaped conductive bodies each curved to form part of the circumference of the certain circle and that are disposed on the circumference of the certain circle at equal spaces, and the horizontal polarization antenna having the smaller diameter of the circle is disposed above the horizontal polarization antenna having the larger diameter of the circle, the parasitic elements 30 can be omitted therefrom.

The invention made by the inventor has been explained specifically on the basis of the example and the modified examples 1, 2 and 3, but this invention is not limited in the example and the modified examples 1, 2 and 3. It should be clear that various modifications can be made without departing from the gist of this invention.

### Reference Signs List

1 . . . Reflector
3a, 3b, 3c, 5a, 5b, 5c, 6a, 6b, 6c, 6j . . . Arc-shaped dipole antenna
4a, 4b, 4c . . . Conductive body
5 . . . Monopole antenna
10₁, 10₂, 10₃, 10_{N} . . . Omnidirectional horizontal polarization antenna
20 . . . Omnidirectional vertical polarization antenna
30 . . . Parasitic element

1-5. (canceled)

6. An antenna comprising:
a planar conductive plate; and
a first omnidirectional antenna to a m-th omnidirectional antenna that are stacked in a first direction perpendicular to a plane of the planer conductive plate, and that have omnidirectivity at a direction parallel to a surface of the planar conductive plate, wherein m is an integer of 2 or more, wherein
each of the first omnidirectional antenna to the m-th omnidirectional antenna has half-wave dipole antennas the number of which is n being an integer of 3 or more, the half-wave dipole antennas being fed in the same phase,
the half-wave dipole antennas, the number of which is n, are configured of arc-shaped conductive bodies each curved to form part of a circumference of a circle, and are disposed on the circumference of the circle at equal spaces, and
a polarization parallel to the surface of the planar conductive plate is transmitted and received.

7. An antenna comprising:
half-wave dipole antennas the number of which is n being an integer of 3 or more, the half-wave dipole antennas being disposed on a circumference of a circle at equal spaces, being configured of arc-shaped conductive bodies each curved to form part of the circumference of the circle, being fed in the same phase, transmitting and receiving a polarization parallel to the circle, and having omnidirectivity at a direction parallel to a plane including the circle; and
monopole antennas the number of which is k being an integer of 3 or more, the monopole antennas being disposed on a circumference of a circle at equal spaces, being fed in the same phase, transmitting and receiving a polarization vertical to the circle, and having omnidirectivity at a direction parallel to the plane including the circle.

8. An antenna comprising:
a reflector; and
a first omnidirectional antenna to a m-th omnidirectional antenna stacked in a first direction perpendicular to a plane of the reflector, and having omnidirectivity at a direction parallel to a surface of the reflector, wherein m is an integer of 2 or more, wherein
each of the first omnidirectional antenna to the m-th omnidirectional antenna has half-wave dipole antennas the number of which is n being an integer of 3 or more, the half-wave dipole antennas being fed in the same phase,
the half-wave dipole antennas, the number of which is n, are respectively configured of arc-shaped conductive bodies each curved to form part of a circumference of a circle, and are disposed on the circumference of the circle at equal spaces, when viewed from a direction opposite to the first direction,
a diameter of the circle is different among the first omnidirectional antenna to the m-th omnidirectional antenna, and
a polarization parallel to the surface of the reflector is transmitted and received.

9. The antenna according to claim 8, further comprising
monopole antennas the number of which is k being an integer of 3 or more, the monopole antennas being disposed on the reflector, being disposed on a circumference of a circle at equal spaces, being fed in the same phase, transmitting and receiving a polarization vertical to the surface of the reflector, and having omnidirectivity at a direction parallel to the surface of the reflector.

10. The antenna according to claim 8, wherein
at least any one of the first omnidirectional antenna to the m-th omnidirectional antenna has, near the half-wave dipole antennas the number of which is n, parasitic elements the number of which is n.

11. The antenna according to claim 9, wherein
at least any one of the first omnidirectional antenna to the m-th omnidirectional antenna has, near the half-wave dipole antennas the number of which is n, parasitic elements the number of which is n.
